(19) United States
(12) Patent Application Publication
(10) Pub. No.: US 2022/0214448 A1
(43) Pub. Date: Jul. 7, 2022

(54) POINT CLOUD DATA FUSION METHOD AND APPARATUS, ELECTRONIC DEVICE, STORAGE MEDIUM AND COMPUTER PROGRAM

(71) Applicant: SHANGHAI SENSETIME INTELLIGENT TECHNOLOGY CO., LTD., Shanghai (CN)

(72) Inventors: Jingwei LI, Shanghai (CN); Zhe WANG, Shanghai (CN)

(73) Assignee: SHANGHAI SENSETIME INTELLIGENT TECHNOLOGY CO., LTD., Shanghai (CN)

(21) Appl. No.: 17/653,275

(22) Filed: Mar. 2, 2022

Related U.S. Application Data
(63) Continuation of application No. PCT/CN2021/089444, filed on Apr. 23, 2021.

(30) Foreign Application Priority Data
Jun. 30, 2020 (CN) 202010618348.2

(51) Int. Cl. G01S 13/89; G01S 13/87; G01S 7/40; G06T 17/20

(52) U.S. Cl. CPC G01S 13/89; G06T 17/20; G01S 7/40; G01S 13/872

(57) ABSTRACT

A point cloud data fusion method includes: point cloud data collected respectively by a primary radar and each secondary radar arranged on a target vehicle is acquired, where the primary radar is one of radars on the target vehicle, and the secondary radar is a radar other than the primary radar among the radars on the target vehicle; a reflectivity in the point cloud data collected by the secondary radar is adjusted based on a pre-determined reflectivity calibration table of the secondary radar to obtain adjusted point cloud data of the secondary radar, where the reflectivity calibration table represents target reflectivity information of the primary radar, which matches each reflectivity corresponding to each scanning line of the secondary radar; and the point cloud data collected by the primary radar and the adjusted point cloud data corresponding to the secondary radar are fused to obtain fused point cloud data.

### CROSS-REFERENCE TO RELATED APPLICATIONS

This is a continuation of International Application No. PCT/CN2021/089444 filed on Apr. 23, 2021, which claims priority to Chinese Patent Application No. 202010618348.2 filed on Jun. 30, 2020. The disclosures of these applications are hereby incorporated by reference in their entirety.

### BACKGROUND

A laser radar detects the position of a target by reflecting a laser beam, which has the characteristics of long detection distance and high measurement precision, and can be thus widely used in the field of automatic driving.

### SUMMARY

The disclosure relates to the technical field of computer vision, and relates, but is not limited, to a point cloud data fusion method and apparatus, an electronic device, a computer-readable storage medium, and a computer program.

Embodiments of the disclosure at least provide a point cloud data fusion method and apparatus, an electronic device, a computer-readable storage medium, and a computer program.

Embodiments of the disclosure provide a point cloud data fusion method, which may include: point cloud data collected respectively by a primary radar and each secondary radar arranged on a target vehicle is acquired, where the primary radar is one of radars on the target vehicle, and the secondary radar is a radar other than the primary radar among the radars on the target vehicle; a reflectivity in the point cloud data collected by the secondary radar is adjusted based on a pre-determined reflectivity calibration table of the secondary radar to obtain adjusted point cloud data of the secondary radar, where the reflectivity calibration table represents target reflectivity information of the primary radar, which matches each reflectivity corresponding to each scanning line of the secondary radar; and the point cloud data collected by the primary radar and the adjusted point cloud data corresponding to the secondary radar are fused to obtain fused point cloud data.

Embodiments of the disclosure further provide a point cloud data fusion apparatus, which may include an acquisition portion, an adjustment portion and a fusion portion. The acquisition portion is configured to acquire point cloud data collected respectively by a primary radar and each secondary radar arranged on a target vehicle. The primary radar is one of radars on the target vehicle, and the secondary radar is a radar other than the primary radar among the radars on the target vehicle. The adjustment portion is configured to adjust, based on a pre-determined reflectivity calibration table of the secondary radar, a reflectivity in the point cloud data collected by the secondary radar to obtain adjusted point cloud data of the secondary radar. The reflectivity calibration table represents target reflectivity information of the primary radar, which matches each reflectivity corresponding to each scanning line of the secondary radar. The fusion portion is configured to fuse the point cloud data collected by the primary radar and the adjusted point cloud data of the secondary radar to obtain fused point cloud data.

Embodiments of the disclosure further provide a computer-readable storage medium, which has stored thereon a computer program that, when executed by a processor, performs a cloud data fusion method, the method including: point cloud data collected respectively by a primary radar and each secondary radar arranged on a target vehicle is acquired, where the primary radar is one of radars on the target vehicle, and the secondary radar is a radar other than the primary radar among the radars on the target vehicle; a reflectivity in the point cloud data collected by the secondary radar is adjusted based on a pre-determined reflectivity calibration table of the secondary radar to obtain adjusted point cloud data of the secondary radar, where the reflectivity calibration table represents target reflectivity information of the primary radar, which matches each reflectivity corresponding to each scanning line of the secondary radar; and the point cloud data collected by the primary radar and the adjusted point cloud data corresponding to the secondary radar are fused to obtain fused point cloud data.

In order that the above objects, features and advantages of the disclosure are more comprehensible, preferred embodiments accompanied with the accompanying drawings are described in detail below.

### BRIEF DESCRIPTION OF THE DRAWINGS

For describing the technical solutions of the embodiments of the disclosure more clearly, the drawings required to be used in the embodiments will be simply introduced below. The drawings, which are incorporated in and constitute a part of this specification, illustrate embodiments consistent with the disclosure and, together with the specification, serve to explain the technical solutions of the disclosure. It is to be understood that the following drawings only illustrate some embodiments of the disclosure and thus should not be considered as limits to the scope. Those of ordinary skill in the art may also obtain other related drawings according to these drawings without creative work.

FIG. 1A is a schematic flowchart of a point cloud data fusion method according to an embodiment of the disclosure.

FIG. 1B is a schematic diagram of an application scenario according to an embodiment of the disclosure.

FIG. 2 is a schematic flowchart of a mode of determining a reflectivity calibration table in a point cloud data fusion method according to an embodiment of the disclosure.

FIG. 3 is a schematic architecture diagram of a point cloud data fusion apparatus according to an embodiment of the disclosure.

FIG. 4 is a schematic structural diagram of an electronic device according to an embodiment of the disclosure.

### DETAILED DESCRIPTION

In order to make the objectives, technical solutions, and advantages of the embodiments of the disclosure clearer, the technical solutions in the embodiments of the disclosure will be clearly and completely described below in combination with the drawings in the embodiments of the disclosure. It is apparent that the described embodiments are not all but only part of embodiments of the disclosure. Components, described and shown in the drawings, of the embodiments of the disclosure may usually be arranged and designed with various configurations. Therefore, the following detailed descriptions about the embodiments of the disclosure provided in the drawings are not intended to limit the claimed scope of the disclosure but only represent selected embodiments of the disclosure. All other embodiments obtained by those skilled in the art based on the embodiments of the disclosure without creative work shall fall within the scope of protection of the disclosure.

Generally, in order to reduce a detection blind area and increase a detection distance, multiple laser radars may be mounted on a vehicle. Manufacturers corresponding to the mounted plurality of laser radars may be different, or models corresponding to the multiple laser radars may be different, thus resulting in inconsistent reflectivity measurement standards of the multiple laser radars, resulting in inconsistent reflectivity measurement standards corresponding to different fused point cloud data, resulting in distortion of a target object characterized by the fused point cloud data, and further resulting in low execution result accuracy when performing tasks such as target detection, target tracking and high-precision map building based on the fused point cloud data.

In some implementations, multiple radars may be arranged on a target vehicle, each radar collects point cloud data respectively, the point cloud data collected by the multiple radars is fused to obtain relatively rich fused point cloud data, and then target detection or target tracking may be performed based on the fused point cloud data. However, the corresponding reflectivities of different radars may be inconsistent, so that the reflectivities of different source point cloud data are not uniform when fusing, and the fused point cloud data obtained has the problem of distortion, which reduces the accuracy of execution results.

Radars in the embodiments of the disclosure include laser radars, millimeter wave radars, ultrasonic radars, etc., and the radars performing point cloud data fusion may be radars of the same type or different types. In the embodiments of the disclosure, the description will be given only with the case that radars performing point cloud data fusion are laser radars.

In some implementations, laser radars may be calibrated manually or automatically. The calibration precision of the manual calibration is high, and the manual calibration result may be taken as a true value. Generally, laser radar manufacturers perform the manual calibration when the device leaves the factory, but the manual calibration requires a special darkroom and calibration device. The automatic calibration mode generally requires the laser radars to perform a certain known motion while collecting point cloud data. However, reflectivity calibration is not performed for multiple laser radars in some implementations.

In order to solve the above technical problem, an embodiment of the disclosure provides a point cloud data fusion method.

In order to facilitate an understanding of the embodiment of the disclosure, a point cloud data fusion method according to the embodiment of the disclosure will first be described in detail.

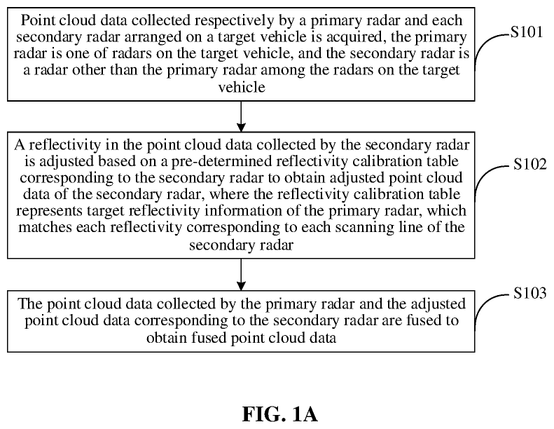

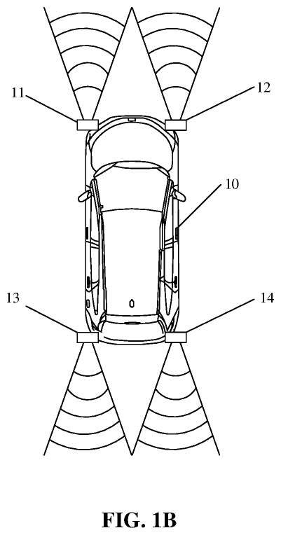

FIG. 1A shows a schematic flowchart of a point cloud data fusion method according to an embodiment of the disclosure. The method includes S101-S103.

In S101, point cloud data collected respectively by a primary radar and each secondary radar arranged on a target vehicle is acquired. The primary radar is one of radars on the target vehicle, and the secondary radar is a radar other than the primary radar among the radars on the target vehicle.

In S102, a reflectivity in the point cloud data collected by the secondary radar is adjusted based on a pre-determined reflectivity calibration table corresponding to the secondary radar to obtain adjusted point cloud data of the secondary radar. The reflectivity calibration table represents target reflectivity information of the primary radar, which matches each reflectivity corresponding to each scanning line of the secondary radar.

In S103, the point cloud data collected by the primary radar and the adjusted point cloud data corresponding to the secondary radar are fused to obtain fused point cloud data.

In some embodiments, the target vehicle may be controlled based on the fused point cloud data. Exemplarily, target detection and target tracking may be performed based on the fused point cloud data, and the target vehicle may be controlled based on detection and tracking results.

In the above method, a reflectivity calibration table is pre-generated, the reflectivity calibration table characterizes target reflectivity information of a primary radar matching each reflectivity corresponding to each scanning line of a secondary radar, and after obtaining point cloud data collected by the secondary radar, a reflectivity in the point cloud data collected by the secondary radar may be adjusted according to the reflectivity calibration table, so that point cloud data collected by the primary radar is consistent with a measurement standard corresponding to the reflectivity in the adjusted point cloud data collected by the secondary radar. Furthermore, the distortion of the fused point cloud data can be relieved, and the accuracy of target detection can be improved.

S101 to S103 are described in detail below.

In some embodiments, the primary and secondary radars may be radars arranged at different positions on the target vehicle, and the primary and secondary radars may be multi-line radars. The types and arrangement positions of the primary and secondary radars may be set according to actual needs, and the number of the secondary radars may be plural. In one example, the primary radar may be a laser radar arranged at a middle position of the target vehicle, i.e. a primary laser radar, and the two secondary radars may be laser radars arranged at positions on both sides of the target vehicle, i.e. a secondary laser radar.

In another example, referring to FIG. 1B, there are four radars on a target vehicle 10, which are a first radar 11, a second radar 12, a third radar 13, and a fourth radar 14, respectively, any one of the first radar 11, the second radar 12, the third radar 13, and the fourth radar 14 is a primary radar, and three of the four radars other than the primary radar are secondary radars.

The primary radar may be a 16-line, 32-line, 64-line or 128-line laser radar, and the secondary radar may be a 16-line, 32-line, 64-line or 128-line laser radar.

After point cloud data is collected by the primary radar and the secondary radar, point cloud data collected by the primary radar and the secondary radar respectively may be acquired. Generally, the point cloud data collected by the primary radar includes data respectively corresponding to multiple scanning points. In the point cloud data collected by the primary radar, the data corresponding to each scanning point includes position information and reflectivity of the scanning point in a rectangular coordinate system corresponding to the primary radar. The point cloud data collected by the secondary radar may include data respectively corresponding to multiple scanning points. In the point cloud data collected by the secondary radar, the data corresponding to each scanning point includes position information and reflectivity of the scanning point in a rectangular coordinate system corresponding to the secondary radar.

In some embodiments, after the point cloud data corresponding to the primary radar and the secondary radar respectively is acquired, coordinate conversion is performed on the point cloud data corresponding to the secondary radar, so that the point cloud data after coordinate conversion and the point cloud data acquired by the primary radar are located in the same coordinate system, i.e. the point cloud data after coordinate conversion is located in the rectangular coordinate system corresponding to the primary radar. A reflectivity in the point cloud data collected by the secondary radar may be adjusted using a pre-determined reflectivity calibration table of the secondary radar to obtain adjusted point cloud data corresponding to the secondary radar. The point cloud data collected by the primary radar and the adjusted point cloud data corresponding to the secondary radar are fused to obtain fused point cloud data.

If there are multiple secondary radars, a corresponding reflectivity calibration table may be generated for each secondary radar, and the point cloud data collected by the corresponding secondary radar may be adjusted using the reflectivity calibration table corresponding to each secondary radar to obtain adjusted point cloud data corresponding to each secondary radar.

For a secondary radar, an m-row n-column reflectivity calibration table may be obtained. m represents the number of scanning lines of the secondary radar, and n represents a reflectivity value range corresponding to each scanning line. It can be seen that when the number of secondary radars is a, a m-row n-column reflectivity calibration tables may be obtained, and a is an integer greater than or equal to 1.

In some embodiments, for a secondary radar, the reflectivity calibration table may be as shown in Table 1 below, and the reflectivity calibration table may be a reflectivity calibration table for a 16-line secondary laser radar. Table 1 includes target reflectivity information of the primary laser radar matching each reflectivity of each scanning line in the secondary laser radar, and 256 reflectivities corresponding to each scanning line (the 256 reflectivities may be reflectivity 0, reflectivity 1, . . . , reflectivity 255). That is, the reflectivity calibration table includes target reflectivity information matching each reflectivity of each scanning line in 16 lines. The target reflectivity information may include a target average reflectivity value, a target reflectivity variance, a target reflectivity maximum value, a target reflectivity minimum value, etc. The target average reflectivity value may be a positive integer, and the target reflectivity variance may be a positive real number. For example, target reflectivity information of a primary laser radar matching a scanning line Ring® and reflectivity 0 may be information X00, and target reflectivity information of a primary laser radar matching a scanning line Ring15 and reflectivity 255 may be information X15255.

TABLE 1
Reflectivity Calibration Table

Reflectivity

| Lines | 0 | 1 | . . . | 255 |
|---|---|---|---|---|
| Ring0 | X00 | X01 | . . . | X0255 |
| Ring1 | X10 | X11 | . . . | X1255 |
| . . . | . . . | . . . | . . . | . . . |
| Ring15 | X150 | X151 | . . . | X15255 |

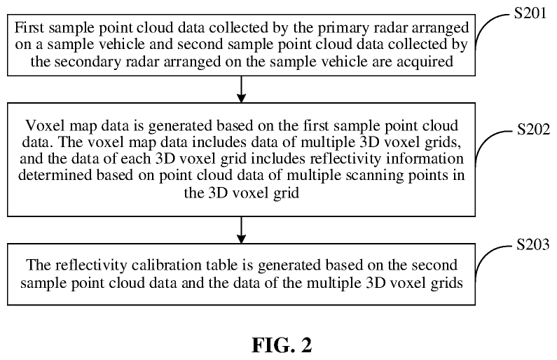

In some embodiments, referring to FIG. 2, the reflectivity calibration table is determined according to the following steps.

In S201, first sample point cloud data collected by the primary radar arranged on a sample vehicle and second sample point cloud data collected by the secondary radar arranged on the sample vehicle are acquired.

In S202, voxel map data is generated based on the first sample point cloud data. The voxel map data includes data of multiple three-dimensional (3D) voxel grids, and the data of each 3D voxel grid includes reflectivity information determined based on point cloud data of multiple scanning points in the 3D voxel grid.

In S203, the reflectivity calibration table is generated based on the second sample point cloud data and the data of the multiple 3D voxel grids.

In some embodiments, the sample vehicle and the target vehicle may be the same vehicle or may be different vehicles. The sample vehicle provided with the primary radar and the secondary radar may be controlled to travel for a preset distance on a preset road to obtain first sample point cloud data and second sample point cloud data. If there are multiple secondary radars, second sample point cloud data corresponding to each secondary radar may be obtained.

In some embodiments, the voxel map data may be generated based on the first sample point cloud data. In specific implementation, the range of the voxel map data may be determined according to the first sample point cloud data. For example, if the first sample point cloud data is sample point cloud data within a first distance range, a second distance range corresponding to the voxel map data may be determined from the first distance range. The second distance range corresponding to the voxel map data is located within the first distance range. And then the voxel map data in the second distance range is divided to obtain multiple 3D voxel grids within the second distance range, and initial data of each 3D voxel grid is determined, i.e. the initial data of each 3D voxel grid is set as a preset initial value. For example, when the data of the 3D voxel grid includes an average reflectivity value, a reflectivity variance and a number of scanning points, the initial data of each 3D voxel grid may be that the average reflectivity value is 0, the reflectivity variance is 0 and the number of scanning points is 0. And then the initial data of each 3D voxel grid is updated using the point cloud data of the multiple scanning points in the first sample point cloud data to obtain updated data of each 3D voxel grid.

The above implementation provides a method for generating a reflectivity calibration table. Voxel map data is generated based on first sample point cloud data to obtain reflectivity information of the first sample point cloud data on each 3D voxel grid, and then a reflectivity calibration table is generated based on second sample point cloud data and the voxel map data. The reflectivity calibration table may more accurately reflect target reflectivity information of a primary radar matching each reflectivity of each scanning line of a secondary radar, i.e. the generated reflectivity calibration table has higher accuracy.

It can be seen that in order to generate the reflectivity calibration table, only the second sample point cloud data and the data of multiple 3D voxel grids need to be acquired without a harsh calibration environment and complicated professional calibration device. In addition, the process of generating the reflectivity calibration table may be automatically implemented based on the second sample point cloud data and the data of the multiple 3D voxel grids without generating the reflectivity calibration table by a large amount of human intervention. Thus, the embodiment of the disclosure can more easily calibrate the reflectivity of the radar.

In some embodiments, the operation that the voxel map data is generated based on the first sample point cloud data includes the following operations.

Multiple pieces of pose data collected sequentially during movement of the sample vehicle is acquired.

De-distortion processing is performed on the first sample point cloud data based on the multiple pieces of pose data to obtain processed first sample point cloud data.

The voxel map data is generated based on the processed first sample point cloud data.

Exemplarily, a positioning device such as a Global Navigation Satellite System-Inertial Navigation System (GNSS-INS) may be arranged on the sample vehicle, the positioning device may be used to position the sample vehicle so as to obtain multiple pieces of pose data collected sequentially during movement of the sample vehicle, and the positioning precision of the positioning device may reach centimeter-level precision. Or, the sample vehicle may be controlled to travel at a constant speed, and multiple pieces of pose data may be calculated according to time when the primary radar or the secondary radar transmits and receives a radio beam.

De-distortion processing may be performed on the first sample point cloud data using the multiple pieces of pose data to obtain processed first sample point cloud data. Since the radar acquires the point cloud data by scanning the environment periodically, when the radar is in a motion state, the generated point cloud data will be distorted, and the de-distortion mode is to convert the obtained point cloud data to the same time, i.e. the point cloud data after de-distortion may be considered to be the point cloud data obtained at the same time. Therefore, the processed first sample point cloud data may be understood as the first sample point cloud data obtained at the same time. Then the voxel map data may be generated based on the processed first sample point cloud data.

In the above implementation, the de-distortion processing process may eliminate a deviation caused by different radar positions corresponding to different frames of first sample point cloud data and a deviation caused by different batches of first sample point cloud data in each frame of first sample point cloud data, so that the processed first sample point cloud data may be understood as the first sample point cloud data measured at the same radar position, when the voxel map data is generated based on the first sample point cloud data obtained after de-distortion processing, the accuracy of the generated voxel map data can be improved, and the reflectivity calibration table can be generated with high accuracy.

In some embodiments, the reflectivity information includes an average reflectivity value, and the data of each 3D voxel grid included in the voxel map data is determined according to the following steps.

For each of the 3D voxel grids, an average reflectivity value corresponding to the 3D voxel grid is determined based on a reflectivity of the point cloud data of each scanning point in the 3D voxel grid.

In the embodiment of the disclosure, the 3D voxel grid where each scanning point is located may be determined according to the position information corresponding to each scanning point in the first sample point cloud data, and then various scanning points included in each 3D voxel grid may be obtained. For each 3D voxel grid, the reflectivity of each scanning point in the 3D voxel grid is averaged to obtain an average reflectivity value corresponding to the 3D voxel grid.

In some embodiments, the operation that the reflectivity calibration table is generated based on the second sample point cloud data and the data of the multiple 3D voxel grids may include the following operations.

For each reflectivity of each scanning line of the secondary radar, position information of multiple target scanning points corresponding to the reflectivity is determined from the second sample point cloud data. The multiple target scanning points are scanning points obtained by scanning through the scanning line. At least one 3D voxel grid corresponding to the multiple target scanning points is determined based on the position information of the multiple target scanning points. Target reflectivity information of the primary radar matching the reflectivity of the scanning line is determined based on the average reflectivity value corresponding to the at least one 3D voxel grid.

The reflectivity calibration table is generated based on the determined target reflectivity information of the primary radar matching each reflectivity of each scanning line of the secondary radar.

For example, for a scanning line Ring1 and reflectivity 1 of a secondary radar, a scanning point scanned by the scanning line Ring1 is determined from second sample point cloud data, and multiple target scanning points with reflectivity 1 may be determined from the scanning point which may be scanned by Ring1. At least one 3D voxel grid corresponding to the multiple target scanning points is determined according to position information of the multiple target scanning points. A target average reflectivity value and a target reflectivity variance (the target average reflectivity value and the target reflectivity variance are target reflectivity information) of the primary radar matching the scanning line Ring1 and reflectivity 1 may be calculated based on the average reflectivity value corresponding to at least one 3D voxel grid. Then the reflectivity calibration table may be generated based on the target reflectivity information of the primary radar matching each reflectivity of each scanning line of the secondary radar.

In some embodiments, multiple target scanning points corresponding to each reflectivity of each scanning line are determined by traversing the second sample point cloud data. Then at least one 3D voxel grid corresponding to each reflectivity of each scanning line is determined based on position information of the multiple target scanning points. Then target reflectivity information of the primary radar respectively matching each reflectivity of each scanning line may be determined based on an average reflectivity value corresponding to at least one 3D voxel grid corresponding to each reflectivity of each scanning line. Finally, the reflectivity calibration table is generated based on the target reflectivity information of the primary radar respectively matching each reflectivity of each scanning line.

Multiple target scanning points corresponding to each reflectivity of each scanning line are determined by traversing the second sample point cloud data. Then at least one 3D voxel grid corresponding to each reflectivity of each scanning line is determined based on position information of the multiple target scanning points, i.e. at least one 3D voxel grid corresponding to each box in the reflectivity calibration table is determined. Then target reflectivity information in each box may be determined based on an average reflectivity value corresponding to at least one 3D voxel grid corresponding to each box, and the reflectivity calibration table is generated.

It can be understood that when radio beams generated by different radars impinge on the same object, the corresponding reflectivities should be consistent, i.e. it can be considered that the reflectivity of the scanning point scanned by the primary radar is consistent with the reflectivity of the scanning point scanned by the secondary radar in the same 3D voxel grid. Therefore, at least one 3D voxel grid corresponding to each reflectivity of each scanning line of the secondary radar may be determined, target reflectivity information of the primary radar matching the reflectivity of this scanning line may be more accurately determined according to an average reflectivity value corresponding to at least one 3D voxel grid, and then a more accurate reflectivity calibration table may be generated.

In some embodiments, the data of the 3D voxel grid includes the average reflectivity value, and a weight influence factor including at least one of a reflectivity variance or a number of scanning points.

In a case where the at least one 3D voxel grid includes multiple 3D voxel grids, the operation that the target reflectivity information of the primary radar matching the reflectivity of the scanning line is determined based on the average reflectivity value corresponding to the at least one 3D voxel grid includes the following operations.

A weight corresponding to each of the at least one 3D voxel grid is determined based on the weight influence factor.

The target reflectivity information of the primary radar matching the reflectivity of the scanning line is determined based on the weight corresponding to each 3D voxel grid and the corresponding average reflectivity value thereof.

Here, the weight corresponding to each of the at least one 3D voxel grid may be determined according to the weight influence factor after determining at least one 3D voxel grid corresponding to each reflectivity of each scanning line of the secondary radar.

For example, when the weight influence factor is the reflectivity variance value, the weight of the 3D voxel grid with a large reflectivity variance may be set smaller, and the weight of the 3D voxel grid with a small reflectivity variance may be set larger. When the weight influence factor is the number of scanning points, the weight of the 3D voxel grid with a larger number of scanning points may be set larger, and the weight of the 3D voxel grid with a smaller number of scanning points may set smaller. When the weight influence factor includes the reflectivity variance and the number of scanning points, the weight of the 3D voxel grid with a small reflectivity variance and a large number of scanning points is set larger, and the weight of the 3D voxel grid with a large reflectivity variance and a small number of scanning points is set smaller, etc.

Further, a target average reflectivity value may be obtained by weighted averaging based on the weight corresponding to each 3D voxel grid and the average reflectivity value, and a target reflectivity variance may be obtained by weighted variance, i.e. the target reflectivity information of the primary radar matching each reflectivity of each scanning line is obtained.

In some embodiments, a weight may be determined for each 3D voxel grid, the weight of the 3D voxel grid with high credibility is set larger (for example, the 3D voxel grid with a small reflectivity variance and a large number of scanning points has high credibility), and the weight of the 3D voxel grid with low credibility is set smaller, so that the target reflectivity information of the primary radar matching the reflectivity of this scanning line may be determined more accurately based on the weight corresponding to each 3D voxel grid and the average reflectivity value, and thus the obtained reflectivity calibration table may have high accuracy.

In some embodiments, the operation that the reflectivity calibration table is generated based on the second sample point cloud data and the data of the multiple 3D voxel grids includes the following operations.

Multiple pieces of pose data collected sequentially during movement of the sample vehicle is acquired, and de-distortion processing is performed on the second sample point cloud data based on the multiple pieces of pose data to obtain processed second sample point cloud data. Relative position information between the first sample point cloud data and the second sample point cloud data is determined based on position information of the primary radar on the sample vehicle and position information of the secondary radar on the sample vehicle. Coordinate conversion is performed on the processed second sample point cloud data using the relative position information to obtain second sample point cloud data in a target coordinate system. The target coordinate system is a coordinate system corresponding to the first sample point cloud data. The reflectivity calibration table is generated based on the second sample point cloud data in the target coordinate system and the data of the multiple 3D voxel grids.

Here, multiple pieces of pose data corresponding to the sample vehicle may be acquired, and de-distortion processing may be performed on the second sample point cloud data based on the multiple pieces of pose data to obtain processed second sample point cloud data. Coordinate conversion is performed on the second sample point cloud data using the determined relative position information to obtain second sample point cloud data in the target coordinate system, so that the second sample point cloud data obtained after coordinate conversion and the first sample point cloud data are located in the same coordinate system. Finally, the reflectivity calibration table is generated using the second sample point cloud data in the target coordinate system and the data of the multiple 3D voxel grids.

In some embodiments, the second sample point cloud data may first be subjected to de-distortion processing so as to eliminate a deviation caused by different radar positions corresponding to each batch of sample point cloud data and each frame of sample point cloud data in the second sample point cloud data. Then the second sample point cloud data is converted to a target coordinate system corresponding to the first sample point cloud data, and a deviation caused by different radar positions corresponding to the second sample point cloud data and the first sample point cloud data is eliminated, so that when the reflectivity calibration table is generated based on the second sample point cloud data obtained after de-distortion processing and coordinate conversion, the accuracy of the generated reflectivity calibration table can be improved.

In some embodiments, the first sample point cloud data and the second sample point cloud data may be taken as target sample point cloud data respectively, the primary radar is taken as a target radar when the target sample point cloud data is the first sample point cloud data, and the secondary laser radar is taken as a target radar when the target sample point cloud data is the second sample point cloud data. There are multiple frames of the target sample point cloud data each including target sample point cloud data collected through multiple scanning lines transmitted by the target radar. The target radar transmits scanning lines in batches according to a preset frequency and transmits multiple scanning lines in each batch.

In some embodiments, de-distortion processing may be performed on the target sample point cloud data according to the following steps.

Pose information of the target radar when the target radar transmits the scanning lines in each batch is determined based on the multiple pieces of pose data.

For target sample point cloud data collected through scanning lines transmitted in a non-first batch among each frame of target sample point cloud data, coordinates of the target sample point cloud data collected through the scanning lines in the non-first batch are converted to a coordinate system of a target radar corresponding to target sample point cloud data collected through scanning lines transmitted in a first batch among the each frame of target sample point cloud data based on pose information of the target radar when the target radar transmits the scanning lines in the non-first batch, so as to obtain target sample point cloud data subjected to first de-distortion corresponding to the each frame of target sample point cloud data.

For any non-first frame of target sample point cloud data among multiple frames of target sample point cloud data subjected to the first de-distortion, coordinates of the non-first frame of target sample point cloud data are converted to a coordinate system of a target radar corresponding to a first frame of target sample point cloud data based on pose information of the target radar when scanning to obtain the non-first frame of target sample point cloud data, so as to obtain target sample point cloud data subjected to second de-distortion corresponding to the non-first frame of target sample point cloud data.

Here, when the target sample point cloud data is the first sample point cloud data, the first sample point cloud data may include multiple frames of first sample point cloud data, and each frame of first sample point cloud data includes first sample point cloud data in multiple batches. When performing de-distortion processing on the first sample point cloud data, for each frame of first sample point cloud data in the first sample point cloud data, the first sample point cloud data collected by transmitting scanning lines in the not-first batch in this frame of first sample point cloud data may be converted to the coordinate system of the primary radar corresponding to time when scanning lines in the first batch are transmitted in this frame of first sample point cloud data to complete first de-distortion processing. After the first de-distortion processing, for any non-first frame of first sample point cloud data in the multiple frames of first sample point cloud data, the coordinates of this frame of first sample point cloud data is also converted to the coordinate system of the primary radar corresponding to the first frame of first sample point cloud data to complete second de-distortion processing.

For example, if the first sample point cloud data includes 50 frames of first sample point cloud data, i.e. a first frame of first sample point cloud data, a second frame of first sample point cloud data, . . . , a fiftieth frame of first sample point cloud data, each frame of first sample point cloud data includes 10 batches of first sample point cloud data, i.e. a first batch of first sample point cloud data, a second batch of first sample point cloud data, . . . , a tenth batch of first sample point cloud data. For each batch of first sample point cloud data in the second batch of first sample point cloud data to the tenth batch of first sample point cloud data among each frame of first sample point cloud data, pose information when the primary radar transmits scanning lines in this batch is determined by means of an interpolation method, the coordinates of this batch of first sample point cloud data (i.e., the first sample point cloud data collected through scanning lines in this batch) are converted to the coordinate system of the primary radar corresponding to time when scanning lines in the first batch are transmitted in this frame of first sample point cloud data, i.e. to the coordinate system of the primary radar corresponding to the first batch of first sample point cloud data in this frame of first sample point cloud data, and then first sample point cloud data corresponding to each frame of first sample point cloud data after first de-distortion may be obtained.

For each frame of first sample point cloud data among the second frame of first sample point cloud data to the fiftieth frame of first sample point cloud data, the coordinates of this frame of first sample point cloud data are converted to the coordinate system of the primary radar corresponding to the first frame of first sample point cloud data based on pose information of the primary radar when scanning to obtain this frame of first sample point cloud data, so as to obtain first sample point cloud data subjected to second de-distortion corresponding to the first sample point cloud data.

The de-distortion process of the second sample point cloud data may refer to the de-distortion process of the first sample point cloud data, and will not be elaborated herein.

Here, the target sample point cloud data collected by the non-first batch of scanning lines in each frame of target sample point cloud data and the non-first frame of target sample point cloud data in different frames of target sample point cloud data are uniformly converted to the coordinate system of the target radar corresponding to the first batch of target sample point cloud data in the first frame of target sample point cloud data, thereby improving the accuracy of the generated reflectivity calibration table.

In some embodiments, after the reflectivity calibration table is generated, a reflectivity of the scanning line that has no matching target reflectivity information may also be determined in the reflectivity calibration table. Target reflectivity information of the primary radar corresponding to the reflectivity of the scanning line that has no matching target reflectivity information is determined based on the target reflectivity information of the primary radar in the reflectivity calibration table. The reflectivity calibration table is updated based on determined target reflectivity information of the primary radar corresponding to the reflectivity of the scanning line that has no matching target reflectivity information.

Herein, when there is matching target reflectivity information for each reflectivity of each scanning line in the generated reflectivity calibration table, i.e., when there is corresponding target reflectivity information in each box in the generated reflectivity calibration table, the reflectivity calibration table does not need to be updated.

When there is no matching target reflectivity information for at least one reflectivity of a scanning line in the generated reflectivity calibration table (i.e. when there is no corresponding target reflectivity information in a partial box in the generated reflectivity calibration table), target reflectivity information matching at least one reflectivity may be obtained by means of a linear interpolation method.

For example, if there is no matching target reflectivity information in a box corresponding to Ring1 and reflectivity 5, there is target reflectivity information in a box corresponding to Ring1 and reflectivity 4 and there is target reflectivity information in a box corresponding to Ring1 and reflectivity 6, the target reflectivity information in the box corresponding to Ring1 and reflectivity 5 may be obtained by means of a linear interpolation method according to the target reflectivity information in the box corresponding to Ring1 and reflectivity 4 and the target reflectivity information in the box corresponding to Ring1 and reflectivity 6 in the reflectivity calibration table.

Or, if there is no matched target reflectivity information in a box corresponding to Ring1 and reflectivity 5, there is target reflectivity information in a box corresponding to Ring0 and reflectivity 5 and there is target reflectivity information in a box corresponding to Ring2 and reflectivity 5, the target reflectivity information in the box corresponding to Ring1 and reflectivity 5 may be obtained by means of a linear interpolation method according to the target reflectivity information in the box corresponding to Ring0 and reflectivity 5 and the target reflectivity information in the box corresponding to Ring2 and reflectivity 5 in the reflectivity calibration table.

Here, the reflectivity calibration table may be updated based on the determined target reflectivity information of the primary radar corresponding to at least one reflectivity, and an updated reflectivity calibration table is generated. In the updated reflectivity calibration table, a target average reflectivity value in the target reflectivity information may be a positive integer, i.e. the target average reflectivity value corresponding to each box in the reflectivity calibration table may be adjusted to be a positive integer by rounding off, and the updated reflectivity calibration table is generated.

Of course, there are various ways of determining the target reflectivity information of the primary radar corresponding to at least one reflectivity, which are not limited to the recorded contents.

In some embodiments, since there may be a part of the boxes in the generated reflectivity calibration table without corresponding target reflectivity information, i.e. there may be a case where the generated reflectivity calibration table is incomplete, in order to ensure the integrity of the reflectivity calibration table, the target reflectivity information lacking in the reflectivity calibration table may be determined based on the target reflectivity information of the primary radar existing in the reflectivity calibration table, and the reflectivity calibration table is complemented to generate an updated reflectivity calibration table, i.e. a complete reflectivity calibration table is obtained.

It will be appreciated by those skilled in the art that the order in which the steps are written in the above method of the specific implementation does not imply a strict order of execution but constitutes any limitation on the implementation process, and that the specific order in which the steps are performed should be determined in terms of their functionality and possible inherent logic.

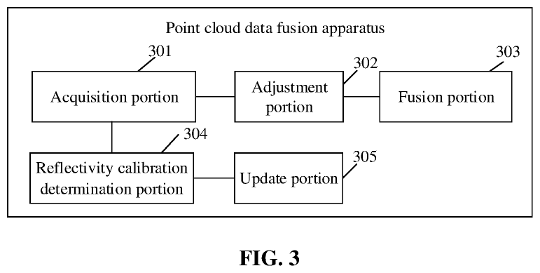

Based on the same technical concept, embodiments of the disclosure further provide a point cloud data fusion apparatus. FIG. 3 shows a schematic architecture diagram of a point cloud data fusion apparatus according to an embodiment of the disclosure. The apparatus includes an acquisition portion 301, an adjustment portion 302, a fusion portion 303, a reflectivity calibration determination portion 304, and an update portion 305.

The acquisition portion 301 is configured to acquire point cloud data collected respectively by a primary radar and each secondary radar arranged on a target vehicle. The primary radar is one of radars on the target vehicle, and the secondary radar is a radar other than the primary radar among the radars on the target vehicle.

The adjustment portion 302 is configured to adjust, based on a pre-determined reflectivity calibration table of the secondary radar, a reflectivity in the point cloud data collected by the secondary radar to obtain adjusted point cloud data of the secondary radar. The reflectivity calibration table represents target reflectivity information of the primary radar, which matches each reflectivity corresponding to each scanning line of the secondary radar.

The fusion portion 303 is configured to fuse the point cloud data collected by the primary radar and the adjusted point cloud data corresponding to the secondary radar to obtain fused point cloud data, and control the target vehicle according to the fused point cloud data.

In some embodiments, the fusion apparatus further includes the reflectivity calibration determination portion 304.

The reflectivity calibration determination portion 304 is configured to determine the reflectivity calibration table according to the following steps.

First sample point cloud data collected by the primary radar arranged on a sample vehicle and second sample point cloud data collected by the secondary radar arranged on the sample vehicle are acquired.

Voxel map data is generated based on the first sample point cloud data. The voxel map data includes data of multiple 3D voxel grids, and the data of each 3D voxel grid includes reflectivity information determined based on point cloud data of multiple scanning points in each of the 3D voxel grids.

The reflectivity calibration table is generated based on the second sample point cloud data and the data of the multiple 3D voxel grids.

In some embodiments, the reflectivity calibration determination portion 304 is configured to perform the following operations when generating the voxel map data based on the first sample point cloud data.

Multiple pieces of pose data collected sequentially during movement of the sample vehicle is acquired.

De-distortion processing is performed on the first sample point cloud data based on the multiple pieces of pose data to obtain processed first sample point cloud data.

The voxel map data is generated based on the processed first sample point cloud data.

In some embodiments, the reflectivity information includes an average reflectivity value, and the reflectivity calibration determination portion 304 is configured to determine the data of each 3D voxel grid included in the voxel map data according to the following steps.

For each of the 3D voxel grids, an average reflectivity value corresponding to each of the 3D voxel grids is determined based on a reflectivity of the point cloud data of each scanning point in each of the 3D voxel grids.

The reflectivity calibration determination portion 304 is configured to perform the following operations when generating the reflectivity calibration table based on the second sample point cloud data and the data of the multiple 3D voxel grids.

For each reflectivity of each scanning line of the secondary radar, position information of multiple target scanning points corresponding to each reflectivity is determined from the second sample point cloud data. The multiple target scanning points are scanning points obtained by scanning through the scanning line. At least one 3D voxel grid corresponding to the multiple target scanning points is determined based on the position information of the multiple target scanning points. Target reflectivity information of the primary radar matching each reflectivity of each scanning line is determined based on the average reflectivity value corresponding to the at least one 3D voxel grid.

The reflectivity calibration table is generated based on the determined target reflectivity information of the primary radar matching each reflectivity of each scanning line of the secondary radar.

In some embodiments, the data of the 3D voxel grid includes the average reflectivity value, and a weight influence factor including at least one of a reflectivity variance or a number of scanning points.

In a case where the at least one 3D voxel grid includes multiple 3D voxel grids, the reflectivity calibration determination portion is configured to perform the following operations when determining the target reflectivity information of the primary radar matching each reflectivity of each scanning line based on the average reflectivity value corresponding to the at least one 3D voxel grid.

A weight corresponding to each of the at least one 3D voxel grid is determined based on the weight influence factor.

The target reflectivity information of the primary radar matching each reflectivity of each scanning line is determined based on the weight corresponding to each 3D voxel grid and the corresponding average reflectivity value thereof.

In some embodiments, the reflectivity calibration determination portion 304 is configured to perform the following operations when generating the reflectivity calibration table based on the second sample point cloud data and the data of the multiple 3D voxel grids.

Multiple pieces of pose data collected sequentially during movement of the sample vehicle is acquired, and de-distortion processing is performed on the second sample point cloud data based on the multiple pieces of pose data to obtain processed second sample point cloud data.

Relative position information between the first sample point cloud data and the second sample point cloud data is determined based on position information of the primary radar on the sample vehicle and position information of the secondary radar on the sample vehicle.

Coordinate conversion is performed on the processed second sample point cloud data using the relative position information to obtain second sample point cloud data in a target coordinate system. The target coordinate system is a coordinate system corresponding to the first sample point cloud data.

The reflectivity calibration table is generated based on the second sample point cloud data in the target coordinate system and the data of the multiple 3D voxel grids.

In some embodiments, the first sample point cloud data and the second sample point cloud data are taken as target sample point cloud data respectively, the primary radar is taken as a target radar when the target sample point cloud data is the first sample point cloud data, and the secondary laser radar is taken as a target radar when the target sample point cloud data is the second sample point cloud data. There are multiple frames of the target sample point cloud data each including sample point cloud data collected through multiple scanning lines transmitted by the target radar. The target radar transmits scanning lines in batches according to a preset frequency and transmits multiple scanning lines in each batch.

The reflectivity calibration determination portion 304 is configured to perform de-distortion processing on the target sample point cloud data according to the following steps.

Pose information of the target radar when the target radar transmits the scanning lines in each batch is determined based on the multiple pieces of pose data.

For target sample point cloud data collected through scanning lines transmitted in a non-first batch among each frame of target sample point cloud data, coordinates of the target sample point cloud data collected through the scanning lines transmitted in the batch are converted to a coordinate system of a target radar corresponding to target sample point cloud data collected by transmitting scanning lines in the first batch in each frame of target sample point cloud data based on pose information of the target radar when the target radar transmits scanning lines not in the first batch, so as to obtain target sample point cloud data subjected to first de-distortion corresponding to the each frame of target sample point cloud data.

For any non-first frame of target sample point cloud data among multiple frames of target sample point cloud data subjected to the first de-distortion, coordinates of the any non-first frame of target sample point cloud data are converted to a coordinate system of a target radar corresponding to the first frame of target sample point cloud data based on pose information of the target radar when scanning to obtain the any non-first frame of target sample point cloud data, so as to obtain target sample point cloud data subjected to second de-distortion corresponding to the any non-first frame of target sample point cloud data.

In some embodiments, the fusion apparatus further includes an update portion 305. The update portion 305 is configured to:

determine the reflectivity of a scanning line, in the reflectivity calibration table, a reflectivity of the scanning line that has no matching target reflectivity information;

determine, based on the target reflectivity information of the primary radar in the reflectivity calibration table, target reflectivity information of the primary radar corresponding to the reflectivity of the scanning line that has no matching target reflectivity information; and

update the reflectivity calibration table based on determined target reflectivity information of the primary radar corresponding to the reflectivity of the scanning line that has no matching target reflectivity information.

In some embodiments, functions or templates of the apparatus provided by the embodiment of the disclosure may be configured to perform the method as described above with respect to the method embodiment, and the specific implementation thereof may be described with reference to the description of the method embodiment and, for brevity, will not be elaborated herein.

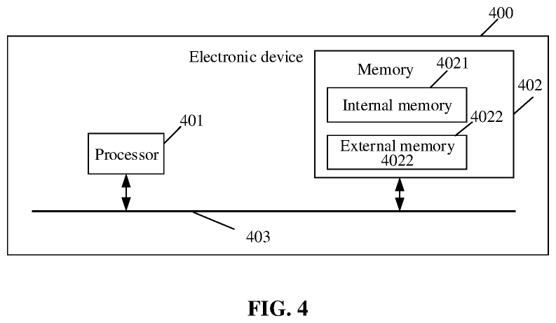

Based on the same technical concept, embodiments of the disclosure further provide an electronic device. FIG. 4 shows a schematic structural diagram of an electronic device 400 according to an embodiment of the disclosure. The electronic device includes a processor 401, a memory 402, and a bus 403. The memory 402 is configured to store execution instructions, and includes a memory 4021 and an external memory 4022. The memory 4021 here is also referred to as an internal memory, and is configured to temporarily store operation data in the processor 401 and data exchanged with the external memory 4022 such as a hard disk. The processor 401 exchanges data with the external memory 4022 through the memory 4021. When the electronic device 400 operates, the processor 401 communicates with the memory 402 through the bus 403, so that the processor 401 performs any point cloud data fusion method as described above.

Embodiments of the disclosure further provide a computer-readable storage medium, which has a computer program stored thereon which, when executed by a processor, performs the point cloud data fusion method described in any of the above method embodiments.

Embodiments of the disclosure further provide a computer program, which may include computer-readable codes. When the computer-readable codes are executed in an electronic device, a processor in the electronic device may perform any point cloud data fusion method as described above. The computer program may specifically refer to the above method embodiments, and will not be elaborated herein.

Those skilled in the art may clearly learn about that specific working processes of the system and apparatus described above may refer to the corresponding processes in the method embodiment and will not be elaborated herein for convenient and brief description. In some embodiments provided by the disclosure, it is to be understood that the disclosed system, apparatus, and method may be implemented in another manner. The apparatus embodiment described above is only schematic. For example, division of the units is only logic function division, and other division manners may be adopted during practical implementation. For another example, multiple units or components may be combined or integrated into another system, or some characteristics may be neglected or not executed. In addition, coupling or direct coupling or communication connection between each displayed or discussed component may be indirect coupling or communication connection, implemented through some communication interfaces, of the apparatus or the units, and may be electrical and mechanical or adopt other forms.

The units described as separate parts may or may not be physically separated, and parts displayed as units may or may not be physical units, and namely may be located in the same place, or may also be distributed to multiple network units. Part or all of the units may be selected to achieve the purpose of the solutions of the embodiments according to a practical requirement.

In addition, each functional unit in each embodiment of the disclosure may be integrated into a processing unit, each unit may also physically exist independently, and two or more than two units may also be integrated into a unit.

When realized in form of a software function unit and sold or used as an independent product, the function may also be stored in a non-volatile computer-readable storage medium executable for the processor. Based on such an understanding, the technical solutions of the disclosure substantially or parts making contributions to the conventional art or part of the technical solutions may be embodied in form of software product, and the computer software product is stored in a storage medium, including multiple instructions configured to enable a computer device (which may be a personal computer, a server, a network device, etc.) to execute all or part of the steps of the method in each embodiment of the disclosure. The foregoing storage medium includes various media capable of storing program codes such as a U disk, a mobile hard disk, a ROM, a RAM, a magnetic disk, or an optical disk.

The above are only specific implementations of the disclosure and not intended to limit the scope of protection of the disclosure. Any variations or replacements apparent to those skilled in the art within the technical scope disclosed by the disclosure should fall within the scope of protection of the disclosure. Therefore, the scope of protection of the disclosure should be determined by the scope of protection of the claims.

### INDUSTRIAL APPLICABILITY

The embodiments of the disclosure provide a point cloud data fusion method and apparatus, an electronic device, a storage medium, and a computer program. The method includes the following operations. Point cloud data collected respectively by a primary radar and each secondary radar arranged on a target vehicle is acquired. The primary radar is one of radars on the target vehicle, and the secondary radar is a radar other than the primary radar among the radars on the target vehicle. A reflectivity in the point cloud data collected by the secondary radar is adjusted based on a pre-determined reflectivity calibration table of the secondary radar to obtain adjusted point cloud data of the secondary radar. The reflectivity calibration table represents target reflectivity information of the primary radar, which matches each reflectivity corresponding to each scanning line of the secondary radar. The point cloud data collected by the primary radar and the adjusted point cloud data corresponding to the secondary radar are fused to obtain fused point cloud data. With the above method, a reflectivity calibration table is pre-generated, the reflectivity calibration table characterizes target reflectivity information of a primary radar matching each reflectivity corresponding to each scanning line of a secondary radar, and after obtaining point cloud data collected by the secondary radar, a reflectivity in the point cloud data collected by the secondary radar may be adjusted according to the reflectivity calibration table, so that point cloud data collected by the primary radar is consistent with a measurement standard corresponding to the reflectivity in the adjusted point cloud data collected by the secondary radar. Furthermore, the distortion of the fused point cloud data can be relieved, and the accuracy of target detection can be improved.

What is claimed is:

1. A point cloud data fusion method, applied to an electronic device, the method comprising:
acquiring point cloud data collected respectively by a primary radar and each secondary radar arranged on a target vehicle, the primary radar being one of radars on the target vehicle, and the secondary radar being a radar other than the primary radar among the radars on the target vehicle;
adjusting, based on a pre-determined reflectivity calibration table of the secondary radar, a reflectivity in the point cloud data collected by the secondary radar to obtain adjusted point cloud data of the secondary radar, wherein the reflectivity calibration table represents target reflectivity information of the primary radar, which matches each reflectivity corresponding to each scanning line of the secondary radar; and
fusing the point cloud data collected by the primary radar and the adjusted point cloud data of the secondary radar to obtain fused point cloud data.

2. The point cloud data fusion method of claim 1, wherein the reflectivity calibration table is determined by:
acquiring first sample point cloud data collected by the primary radar arranged on a sample vehicle and second sample point cloud data collected by the secondary radar arranged on the sample vehicle;
generating voxel map data based on the first sample point cloud data, wherein the voxel map data comprises data of a plurality of three-dimensional (3D) voxel grids, and the data of each 3D voxel grid comprises reflectivity information determined based on point cloud data of a plurality of scanning points in each of the 3D voxel grids; and
generating the reflectivity calibration table based on the second sample point cloud data and the data of the plurality of 3D voxel grids.

3. The point cloud data fusion method of claim 2, wherein generating the voxel map data based on the first sample point cloud data comprises:
acquiring a plurality of pieces of pose data collected sequentially during movement of the sample vehicle;
performing de-distortion processing on the first sample point cloud data based on the plurality of pieces of pose data to obtain processed first sample point cloud data; and
generating the voxel map data based on the processed first sample point cloud data.

4. The point cloud data fusion method of claim 2, wherein the reflectivity information comprises an average reflectivity value, and the data of each 3D voxel grid comprised in the voxel map data is determined by:
determining, for each of the 3D voxel grids, an average reflectivity value corresponding to the 3D voxel grid based on a reflectivity of the point cloud data of each scanning point in the 3D voxel grid,
wherein generating the reflectivity calibration table based on the second sample point cloud data and the data of the plurality of 3D voxel grids comprises:
determining, for each reflectivity of each scanning line of the secondary radar, position information of a plurality of target scanning points corresponding to the reflectivity from the second sample point cloud data, the plurality of target scanning points being scanning points obtained by scanning through the scanning line; determining at least one 3D voxel grid corresponding to the plurality of target scanning points based on the position information of the plurality of target scanning points; determining target reflectivity information of the primary radar matching the reflectivity of the scanning line based on the average reflectivity value corresponding to the at least one 3D voxel grid; and
generating the reflectivity calibration table based on determined target reflectivity information of the primary radar matching each reflectivity of each scanning line of the secondary radar.

5. The point cloud data fusion method of claim 4, wherein the data of the 3D voxel grid comprises the average reflectivity value, and a weight influence factor comprising at least one of a reflectivity variance or a number of scanning points;
in a case where the at least one 3D voxel grid comprises a plurality of 3D voxel grids, determining the target reflectivity information of the primary radar matching the reflectivity of the scanning line based on the average reflectivity value corresponding to the at least one 3D voxel grid comprises:
determining a weight corresponding to each of the at least one 3D voxel grid based on the weight influence factor; and
determining the target reflectivity information of the primary radar matching the reflectivity of the scanning line based on the weight corresponding to each 3D voxel grid and the corresponding average reflectivity value thereof.

6. The point cloud data fusion method of claim 2, wherein generating the reflectivity calibration table based on the second sample point cloud data and the data of the plurality of 3D voxel grids comprises:
acquiring a plurality of pieces of pose data collected sequentially during movement of the sample vehicle, and performing de-distortion processing on the second sample point cloud data based on the plurality of pieces of pose data to obtain processed second sample point cloud data;
determining relative position information between the first sample point cloud data and the second sample point cloud data based on position information of the primary radar on the sample vehicle and position information of the secondary radar on the sample vehicle;
performing coordinate conversion on the processed second sample point cloud data using the relative position information to obtain second sample point cloud data in a target coordinate system, the target coordinate system being a coordinate system corresponding to the first sample point cloud data; and
generating the reflectivity calibration table based on the second sample point cloud data in the target coordinate system and the data of the plurality of 3D voxel grids.

7. The point cloud data fusion method of claim 3, wherein the first sample point cloud data and the second sample point cloud data are taken as target sample point cloud data respectively, the primary radar is taken as a target radar when the target sample point cloud data is the first sample point cloud data, and the secondary radar is taken as a target radar when the target sample point cloud data is the second sample point cloud data, wherein there are a plurality of frames of the target sample point cloud data each comprising target sample point cloud data collected through a plurality of scanning lines transmitted by the target radar, the target radar transmitting scanning lines in batches according to a preset frequency and transmitting a plurality of scanning lines in each batch;
performing de-distortion processing on the target sample point cloud data by:
determining pose information of the target radar when the target radar transmits the scanning lines in each batch based on the plurality of pieces of pose data;
for target sample point cloud data collected through scanning lines transmitted in a non-first batch among each frame of target sample point cloud data, converting coordinates of the target sample point cloud data collected through the scanning lines transmitted in the non-first batch to a coordinate system of the target radar corresponding to target sample point cloud data collected through scanning lines transmitted in a first batch among the each frame of target sample point cloud data based on pose information of the target radar when the target radar transmits the scanning lines in the non-first batch, so as to obtain target sample point cloud data subjected to first de-distortion corresponding to the each frame of target sample point cloud data; and
for any non-first frame of target sample point cloud data among multiple frames of target sample point cloud data subjected to the first de-distortion, converting coordinates of the non-first frame of target sample point cloud data to a coordinate system of the target radar corresponding to a first frame of target sample point cloud data based on pose information of the target radar when scanning to obtain the non-first frame of target sample point cloud data, so as to obtain target sample point cloud data subjected to second de-distortion corresponding to the non-first frame of target sample point cloud data.

8. The point cloud data fusion method of claim 1, further comprising:
determining, in the reflectivity calibration table, a reflectivity of the scanning line that has no matching target reflectivity information;
determining, based on the target reflectivity information of the primary radar in the reflectivity calibration table, target reflectivity information of the primary radar corresponding to the reflectivity of the scanning line that has no matching target reflectivity information; and
updating the reflectivity calibration table based on determined target reflectivity information of the primary radar corresponding to the reflectivity of the scanning line that has no matching target reflectivity information.

9. A point cloud data fusion apparatus, comprising:
an acquisition portion, configured to acquire point cloud data collected respectively by a primary radar and each secondary radar arranged on a target vehicle, the primary radar being one of radars on the target vehicle, and the secondary radar being a radar other than the primary radar among the radars on the target vehicle;
an adjustment portion, configured to adjust, based on a pre-determined reflectivity calibration table of the secondary radar, a reflectivity in the point cloud data collected by the secondary radar to obtain adjusted point cloud data of the secondary radar, wherein the reflectivity calibration table represents target reflectivity information of the primary radar, which matches each reflectivity corresponding to each scanning line of the secondary radar; and
a fusion portion, configured to fuse the point cloud data collected by the primary radar and the adjusted point cloud data of the secondary radar to obtain fused point cloud data.

10. The point cloud data fusion apparatus of claim 9, further comprising: a reflectivity calibration determination portion,
wherein the reflectivity calibration determination portion is configured to determine the reflectivity calibration table by:
acquiring first sample point cloud data collected by the primary radar arranged on a sample vehicle and second sample point cloud data collected by the secondary radar arranged on the sample vehicle;
generating voxel map data based on the first sample point cloud data, wherein the voxel map data comprises data of a plurality of three-dimensional (3D) voxel grids, and the data of each 3D voxel grid comprises reflectivity information determined based on point cloud data of a plurality of scanning points in each of the 3D voxel grids; and
generating the reflectivity calibration table based on the second sample point cloud data and the data of the plurality of 3D voxel grids.

11. The point cloud data fusion apparatus of claim 10, wherein the reflectivity calibration determination portion is configured to perform the following operations when generating the voxel map data based on the first sample point cloud data:
acquiring a plurality of pieces of pose data collected sequentially during movement of the sample vehicle;
performing de-distortion processing on the first sample point cloud data based on the plurality of pieces of pose data to obtain processed first sample point cloud data; and
generating the voxel map data based on the processed first sample point cloud data.

12. The point cloud data fusion apparatus of claim 10, wherein the reflectivity information comprises an average reflectivity value, and the reflectivity calibration determination portion is configured to determine the data of each 3D voxel grid comprised in the voxel map data by:
determining, for each of the 3D voxel grids, an average reflectivity value corresponding to each of the 3D voxel grids based on a reflectivity of the point cloud data of each scanning point in each of the 3D voxel grids; and
the reflectivity calibration determination portion is configured to perform the following operations when generating the reflectivity calibration table based on the second sample point cloud data and the data of the plurality of 3D voxel grids:
determining, for each reflectivity of each scanning line of the secondary radar, position information of a plurality of target scanning points corresponding to each reflectivity from the second sample point cloud data, the plurality of target scanning points being scanning points obtained by scanning through the scanning line; determining at least one 3D voxel grid corresponding to the plurality of target scanning points based on the position information of the plurality of target scanning points; determining target reflectivity information of the primary radar matching each reflectivity of each scanning line based on the average reflectivity value corresponding to the at least one 3D voxel grid; and
generating the reflectivity calibration table based on determined target reflectivity information of the primary radar matching each reflectivity of each scanning line of the secondary radar.

13. The point cloud data fusion apparatus of claim 12, wherein the data of the 3D voxel grid comprises the average reflectivity value, and a weight influence factor comprising at least one of a reflectivity variance or a number of scanning points;
in a case where the at least one 3D voxel grid comprises a plurality of 3D voxel grids, the reflectivity calibration determination portion is configured to perform the following operations when determining the target reflectivity information of the primary radar matching each reflectivity of each scanning line based on the average reflectivity value corresponding to the at least one 3D voxel grid:
determining a weight corresponding to each of the at least one 3D voxel grid based on the weight influence factor; and
determining the target reflectivity information of the primary radar matching each reflectivity of each scanning line based on the weight corresponding to each 3D voxel grid and the corresponding average reflectivity value thereof.

14. The point cloud data fusion apparatus of claim 10, wherein the reflectivity calibration determination portion is configured to perform the following operations when generating the reflectivity calibration table based on the second sample point cloud data and the data of the plurality of 3D voxel grids:
acquiring a plurality of pieces of pose data collected sequentially during movement of the sample vehicle, and performing de-distortion processing on the second sample point cloud data based on the plurality of pieces of pose data to obtain processed second sample point cloud data;
determining relative position information between the first sample point cloud data and the second sample point cloud data based on position information of the primary radar on the sample vehicle and position information of the secondary radar on the sample vehicle;
performing coordinate conversion on the processed second sample point cloud data using the relative position information to obtain second sample point cloud data in a target coordinate system, the target coordinate system being a coordinate system corresponding to the first sample point cloud data; and
generating the reflectivity calibration table based on the second sample point cloud data in the target coordinate system and the data of the plurality of 3D voxel grids.

15. The point cloud data fusion apparatus of claim 11, wherein the first sample point cloud data and the second sample point cloud data are taken as target sample point cloud data respectively, the primary radar is taken as a target radar when the target sample point cloud data is the first sample point cloud data, and the secondary laser radar is taken as a target radar when the target sample point cloud data is the second sample point cloud data, wherein there are a plurality of frames of the target sample point cloud data each comprising sample point cloud data collected through a plurality of scanning lines transmitted by the target radar, the target radar transmitting scanning lines in batches according to a preset frequency and transmitting a plurality of scanning lines in each batch;
the reflectivity calibration determination portion is configured to perform de-distortion processing on the target sample point cloud data by:
determining pose information of the target radar when the target radar transmits the scanning lines in each batch based on the plurality of pieces of pose data;
for target sample point cloud data collected through scanning lines transmitted in a non-first batch among each frame of target sample point cloud data, converting coordinates of the target sample point cloud data collected through the scanning lines transmitted in the batch to a coordinate system of a target radar corresponding to target sample point cloud data collected through scanning lines transmitted in the first batch among the each frame of target sample point cloud data based on pose information of the target radar when the target radar transmits scanning lines not in the first batch, so as to obtain target sample point cloud data subjected to first de-distortion corresponding to the each frame of target sample point cloud data; and
for any non-first frame of target sample point cloud data among multiple frames of target sample point cloud data subjected to the first de-distortion, converting coordinates of the any non-first frame of target sample point cloud data to a coordinate system of a target radar corresponding to a first frame of target sample point cloud data based on pose information of the target radar when scanning to obtain the any non-first frame of target sample point cloud data, so as to obtain target sample point cloud data subjected to second de-distortion corresponding to the any non-first frame of target sample point cloud data.

16. The point cloud data fusion apparatus of claim 9, further comprising: an update portion, configured to:
determine, in the reflectivity calibration table, a reflectivity of the scanning line that has no matching target reflectivity information;
determine, based on the target reflectivity information of the primary radar in the reflectivity calibration table, target reflectivity information of the primary radar corresponding to the reflectivity of the scanning line that has no matching target reflectivity information; and
update the reflectivity calibration table based on determined target reflectivity information of the primary radar corresponding to the reflectivity of the scanning line that has no matching target reflectivity information.

17. A computer-readable storage medium having stored thereon a computer program that, when executed by a processor, performs the point cloud data fusion method, the method comprising:
acquiring point cloud data collected respectively by a primary radar and each secondary radar arranged on a target vehicle, the primary radar being one of radars on the target vehicle, and the secondary radar being a radar other than the primary radar among the radars on the target vehicle;
adjusting, based on a pre-determined reflectivity calibration table of the secondary radar, a reflectivity in the point cloud data collected by the secondary radar to obtain adjusted point cloud data of the secondary radar, wherein the reflectivity calibration table represents target reflectivity information of the primary radar, which matches each reflectivity corresponding to each scanning line of the secondary radar; and
fusing the point cloud data collected by the primary radar and the adjusted point cloud data of the secondary radar to obtain fused point cloud data.
